(19) United States
(12) Patent Application Publication
(10) Pub. No.: US 2025/0011031 A1
(43) Pub. Date: Jan. 9, 2025

(54) SYSTEM AND METHOD FOR SECURING A TAIL ON A BALE WRAP

(71) Applicants: CNH Industrial America LLC, New Holland, PA (US); CNH Industrial Canada, Ltd., Saskatoon (CA)

(72) Inventors: Jonathan E. Ricketts, Coal Valley, IL (US); Martin J. Roberge, Québec (CA); Cy Werda, Winthrop Harbor, IL (US)

(21) Appl. No.: 18/758,307

(22) Filed: Jun. 28, 2024

Related U.S. Application Data
(60) Provisional application No. 63/512,115, filed on Jul. 6, 2023.

(51) Int. Cl. B65C 9/40; A01F 15/07; B65B 11/04; B65C 9/26; G09F 3/02

(52) U.S. Cl. CPC B65C 9/40; A01F 15/0715; B65B 11/04; B65C 9/26; G09F 3/02; A01F 2015/0745

(57) ABSTRACT

A system for securing a tail of a bale wrap includes a controller having a memory and a processor. The controller is configured to control a bale rotation system to drive a wrapped agricultural bale to rotate within a bale carrier of a baler, to control a monitoring system to monitor for an identifier located on the tail of the bale wrap disposed on the wrapped agricultural bale to locate the tail, and to control a labeling system to attach a plurality of labels along the tail of the bale wrap to secure the tail of the bale wrap upon locating the tail of the bale wrap.

### BACKGROUND

The present disclosure relates generally to a system and method for securing the tail on an agricultural bale.

Agricultural balers are used to compress an agricultural product (e.g., cotton) into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale. The bale wrap may be formed from a natural material(s), such as cotton and/or hemp, a polymeric material (e.g., plastic), such as polyvinyl chloride (PVC), other suitable material(s), or a combination thereof. It is important to make the tail of the bale wrap secure to ensure protection of the agricultural product within the bale.

### BRIEF DESCRIPTION

In certain embodiments, a system for securing a tail of a bale wrap includes a controller having a memory and a processor. The controller is configured to control a bale rotation system to drive a wrapped agricultural bale to rotate within a bale carrier of a baler, to control a monitoring system to monitor for an identifier located on the tail of the bale wrap disposed on the wrapped agricultural bale to locate the tail, and to control a labeling system to attach a plurality of labels along the tail of the bale wrap to secure the tail of the bale wrap upon locating the tail of the bale wrap.

In certain embodiments, a method for securing a tail of a bale wrap includes controlling, via a controller including a memory and a processor, a bale rotation system to drive a wrapped agricultural bale to rotate within a bale carrier of a baler. The method also includes controlling, via the controller, a monitoring system to monitor for an identifier located on the tail of the bale wrap disposed on the wrapped agricultural bale to locate the tail. The method further includes controlling, via the controller, a labeling system to attach a plurality of labels along the tail of the bale wrap to secure the tail of the bale wrap upon locating the tail of the bale wrap.

In certain embodiments, a baler includes a bale rotation system configured to drive a wrapped agricultural bale to rotate within a bale carrier of the baler. The baler also includes a monitoring system configured to monitor for an identifier located on a tail of a bale wrap disposed on the wrapped agricultural bale to locate the tail. The baler further includes a labeling system configured to attach a plurality of labels along the tail of the bale wrap to secure the tail of the bale wrap upon locating the tail of the bale wrap. The baler even further includes a controller including a memory and a processor, wherein the controller is communicatively coupled to the bale rotation system, the monitoring system, and the labeling system. The controller is configured to control the bale rotation system to drive the wrapped agricultural bale to rotate within the bale carrier, to control the monitoring system to monitor for the identifier located on the tail of the bale wrap disposed on the wrapped agricultural bale to locate the tail, and to control the labeling system to attach the plurality of labels along the tail of the bale wrap to secure the tail of the bale wrap upon locating the tail of the bale wrap. The plurality of labels is configured both to secure the tail of the bale wrap for at least six months and to secure the tail of the bale wrap in the presence of up to at least 150 miles per hour wind

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an agricultural system having a monitoring system, a labeling system, and a bale carrier having a bale rotation system, in accordance with aspects of the present disclosure;

FIG. 2 is a schematic diagram of a top view of a portion of a bale wrap having identifiers for respective tails (e.g., different color for bale wrap in tail section), in accordance with aspects of the present disclosure;

FIG. 3 is a schematic diagram of a top view of a portion of a bale wrap having identifiers for respective tails (e.g., identification tags), in accordance with aspects of the present disclosure;

FIG. 4 is a schematic diagram of a bale carrier that may be employed within the agricultural system of FIG. 1, in accordance with aspects of the present disclosure;

FIG. 5 is a flowchart of a method for securing a tail on a bale wrap of a wrapped bale, in accordance with aspects of the present disclosure;

FIG. 6 is a schematic diagram of a bottom view of a portion of a band of a labeling system, in accordance with aspects of the present disclosure;

FIG. 7 is a schematic diagram of a wrapped bale with a tail secured by labels (e.g., having labels on lateral surface only), in accordance with aspects of the present disclosure; and

FIG. 8 is a schematic diagram of a wrapped bale with a tail secured by labels (e.g., having labels on lateral surface and longitudinal ends), in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

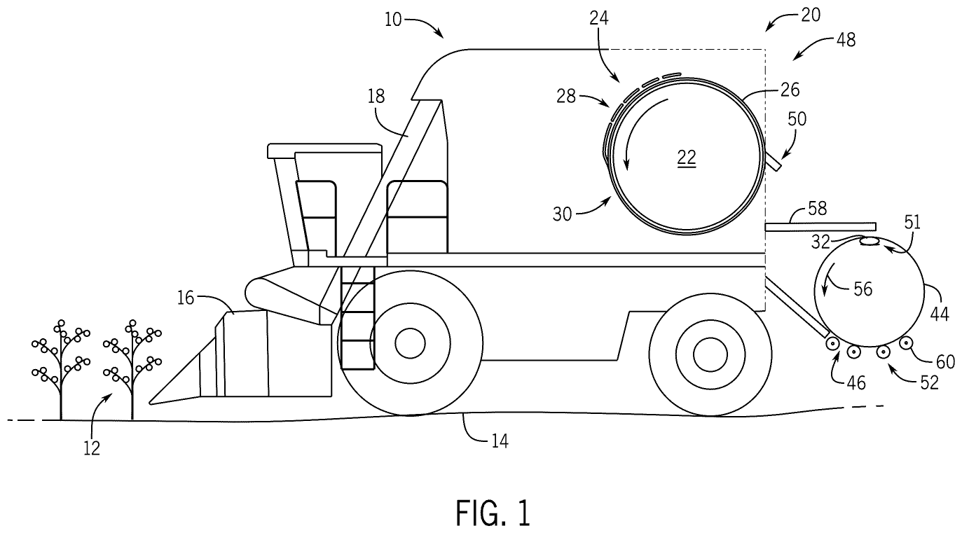

FIG. 1 is a schematic diagram of an embodiment of an agricultural system 10 (e.g., harvester) having an identification printing system. The agricultural system 10 is configured to harvest agricultural product 12 (e.g., cotton) from a field 14 and to form the agricultural product 12 into bales (e.g., agricultural bales). For example, the agricultural system 10 includes a header 16 having drums configured to harvest the agricultural product 12 from the field 14. Additionally, the agricultural system 10 includes an air-assisted system 18 configured to move the agricultural product 12 from the drums of the header 16 to a baler 20. The baler 20 is supported by and/or mounted within or on a chassis of the agricultural system 10. The baler 20 may form the agricultural product 12 into round bales. However, in other embodiments, the baler 20 of the agricultural system 10 may form the agricultural product 12 into square bales, polygonal bales, or bales of other suitable shape(s).

After forming the agricultural product 12 into a bale 22, a bale wrapping system 24 of the agricultural system 10 wraps the bale with a bale wrap 26 to secure the agricultural product 12 within the bale 22 and to generally maintain a shape of the bale 22. In the illustrated embodiment, as the agricultural product 12 (e.g., cotton) is harvested, the agricultural product 12 flows into an accumulator 28 (e.g., bale chamber) and/or a feeding system. For example, cotton may be blown by the air-assisted system into the accumulator/bale chamber 28. The cotton is then fed into a cavity 30 of the baler 20. The baler 20 includes multiple rollers that support and/or drive rotation of one or more belts. One or more rollers are driven to rotate via a belt drive system (e.g., including electric motor(s), hydraulic motor(s), pneumatic motor(s), etc.). The belt(s) circulate around a path, and movement of the belt(s) captures the agricultural product 12 from the accumulator/housing 28 and draws the agricultural product 12 into the cavity 30, where the agricultural product 12 is gradually built up to form the bale 22.

Once the bale 22 reaches a desired size, the bale wrapping system 24 wraps the bale 22 with the bale wrap 26. The bale wrap 26 may include cotton, hemp, flax, other suitable material(s) (e.g., biodegradable material(s), natural material(s)), or a combination thereof. In certain embodiments, the bale wrap 26 may include only cotton. Additionally, the bale wrap 26 may include canvas, fabric, cloth, other suitable material(s), or a combination thereof. Furthermore, in certain embodiments, the bale wrap 26 may include plastic (e.g., polymeric material), such as polyvinyl chloride, etc.

The bale wrap 26 may be fed into contact with the bale 22 with one or more feed rollers and over a wrap guide or wrap applicator (e.g., duckbill). The wrap guide/wrap applicator is configured to move (e.g., rotate) to direct the bale wrap 26 into contact with the bale 22. The bale wrap 26 may be captured between the bale 22 and the belt(s). Accordingly, rotation of the bale 22 draws the bale wrap 26 around the bale 22, thereby wrapping the bale 22.

To secure the bale wrap 26 around the bale 22, the bale wrapping system 24 may include an adhesive system. The adhesive system may include one or more sprayers that spray an adhesive onto the bale wrap 26 (e.g., one side of the bale wrap 26) that makes the one side of the bale wrap 26 tacky or sticky. Additionally or alternatively, the sprayer(s) may spray an activator (e.g., water) onto the bale wrap 26 to activate an adhesive (e.g., water-soluble film, powder embedded within the bale wrap, etc.). Accordingly, the adhesive system may create an adhesive layer that is tacky or sticky on the bale wrap 26, thereby coupling the bale wrap 26 to itself, which secures the bale wrap 26 around the bale 22. For example, a first portion of the bale wrap 26 (e.g., interior surface relative to a central portion of the bale 22) may couple (e.g., adhere) to a second portion (e.g., a backside and/or an exterior surface relative to a central portion of the bale 22) of the bale wrap 26 with the adhesive provided by and/or activated by the adhesive system as the first portion overlaps the second portion. The bale wrap 26 may then be cut with a cutter or cutting system to separate additional bale wrap 26 (e.g., on a roll of bale wrap) from the bale wrap 26 surrounding the bale 22.

The cutting system may cut the bale wrap 26 to a suitable length for wrapping the bale 22. For example, the length of the bale wrap 26 may be selected based on a size of the bale 22 and a desired number of wraps of the bale wrap 26 (e.g., the number of times the bale wrap 26 wraps around a circumferential side of the bale 22). The cutting system may include a cutting mechanism, an actuation assembly coupled to the cutting mechanism, and a track. The cutting mechanism may include a knife that engages the bale wrap 26 to cut the bale wrap 26. In other embodiments, the cutting mechanism may include other suitable mechanism(s) configured to cut the bale wrap 26 (e.g., a rotary knife, a duckbill knife, a saw, a shear bar, etc.). In some embodiments, the actuation assembly is configured to move the cutting mechanism along a track to selectively drive the cutting mechanism into engagement with the bale wrap 26. In certain embodiments, the bale wrap 26 may have partially pre-cut sections (e.g., perforated sections) to facilitate cutting the bale wrap 26 by the cutting system. In certain embodiments, the bale wrap 26 is a continuous roll.

The bale wrap 26 is configured to wrap around the bale 22 to secure the agricultural product 12 within the bale 22 and to generally maintain a shape of the bale 22, such as the round shape in the illustrated embodiment. In other embodiments, the shape of the bale may be rectangular, polygonal, or another suitable shape. The bale wrapping system 24 may wrap the bale 22 with the bale wrap 26 once or multiple times. For example, the bale wrap 26 may form one wrap (e.g., layer), one wrap and a portion of another wrap, two wraps, or five wraps around the bale 22.

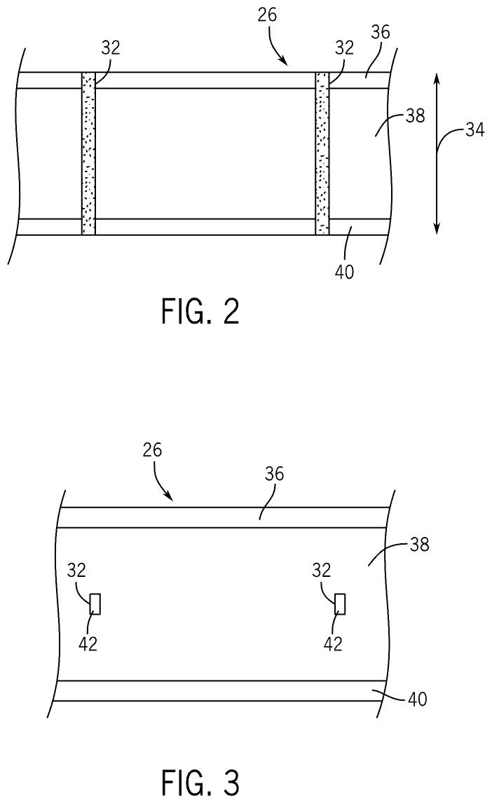

The bale wrap 26 (whether a continuous roll or having perforated sections) includes a plurality of identifiers with each identifier located at a respective tail (e.g., last portion or end) of the portion of the bale wrap 26 to be disposed about a respective bale 22. In certain embodiments, as depicted in FIG. 2 (which is a portion of a roll of the bale wrap 26 if unrolled), an identifier 32 may be a portion of the bale wrap 26 colored differently from the rest of the portion of the bale wrap 26 to be disposed about the respective bale 22. As depicted in FIG. 2, each identifier 26 extends across a width 34 of the bale wrap 26 (e.g. across a first shoulder 36, a central portion 38, and a second shoulder 40 of the bale wrap 26). The shoulders 36, 40 of the bale wrap 26 are configured to be disposed about respective longitudinal ends of the bale 22 while the central portion is disposed about a lateral surface of the bale 22 extending between the longitudinal ends. In certain embodiments, the identifier 26 may extend only across the central portion 38 of the bale wrap 26.

In certain embodiments, as depicted in FIG. 3 (which is a portion of a roll of the bale wrap 26 if unrolled), the identifier 32 may be a tag 42 (e.g., identification tag such as a radio frequency identification (RFID) tag to be read by an RFID reader) located at a tail of the portion of the bale wrap 26 to be disposed about the respective bale 22. As depicted in FIG. 3, each tag 42 is located within the central portion 38 of the bale wrap 26.

Returning to FIG. 1, the adhesive system may spray various circumferential lengths of adhesive/activator along the bale wrap 26. For example, the adhesive system may spray along a circumferential portion of the bale wrap 26 that extends less than 25 percent, 50 percent, 75 percent, or 100 percent of the circumferential extent of the bale 22. The sprayed portion of the bale wrap 26 may also cover more than one wrap of the bale wrap 26. In some embodiments, the portion of the bale wrap 26 sprayed with the adhesive/activator may be a selected length (e.g., 1 cm, 15 cm, 30 cm, 60 cm, 90 cm, 120 cm, 150 cm, or more). Furthermore, the adhesive system may spray various widths of adhesive/activator across the bale wrap 26. For example, the adhesive system may spray across 25 percent, 50 percent, 75 percent, or 100 percent of the width of the bale wrap 26 (e.g., continuously or in sections).

After the bale 22 is wrapped with the bale wrap 26, the wrapped bale 44 (e.g., wrapped agricultural bale) is transferred to a bale carrier 46. As depicted in FIG. 1, the bale carrier 46 is located outside the agricultural system 10 on a rear portion 48 of the agricultural system 10. In certain embodiments, the bale carrier 46 may be located within the agricultural system 10. For example, the baler 20 may include a bale transport system configured to move the wrapped bale 44 from the cavity 30 to the bale carrier 46. The wrapped bale 44 may be stored in the bale carrier 46 until the agricultural system 10 reaches a desired location for ejecting the wrapped bale 44 onto the field 14. An ejection system may then eject the wrapped bale 44 from the bale carrier 46 onto the field 14.

The baler 20 includes a monitoring system 50 communicatively coupled to a controller having a memory and a processor. As depicted in FIG. 1, the monitoring system 50 is located outside the agricultural system 10 on the rear portion 48 of the agricultural system 10. In certain embodiments, the monitoring system 50 may be located within the agricultural system 10. The monitoring system 50 (in conjunction with the controller) is configured to monitor for the identifier 32 located on the tail 51 of the wrapped bale 44 as the wrapped bale 44 is being driven to rotate within the bale carrier 46 (e.g., by a bale rotation system 52 that is part of the bale carrier 46). In certain embodiments, the monitoring system 50 may include a camera or sensor to look for and/or identify the identifier 32 (e.g., when the identifier 32 is a portion of the bale wrap 26 that is a different color from the rest of the bale wrap 26 as described in FIG. 2). In certain embodiments, the monitoring system 50 may include an RFID reader to read or identify the identifier (e.g., when the identifier 32 is an RFID tag as described in FIG. 3).

The baler 20 further includes the bale rotation system 52 communicatively coupled to the controller. The bale rotation system 52 includes a plurality of rollers 60 that are driven to rotate the wrapped bale 44 (as indicated by arrow 56) within the bale carrier 46. The controller controls the rotation of the wrapped bale 44 within the bale carrier 46. In particular, the controller controls rotation of the wrapped bale 44 until the tail 51 of the wrapped bale 44 is identified (via the monitoring system 50 finding the identifier 32) and then causes rotation of the wrapped bale 44 ceases with the tail 51 located at a location where a labeling system 58 applies labels to the tail 51 of the bale wrap 26.

The baler 20 even further includes the labeling system 58 communicatively coupled to the controller. As depicted in FIG. 1, the labeling system 58 is located outside the agricultural system 10 on the rear portion 48 of the agricultural system 10. In certain embodiments, the labeling system 58 may be located within the agricultural system 10. The controller is configured to control the labeling system 58 to attach a plurality of labels along the tail 51 of bale wrap 26 upon locating the tail 51 of the bale wrap 26. The labeling system 58 may include a band that is actuated (via one or more actuators) via a control signal to apply the plurality of labels at the same time on the tail 51 of the bale wrap 26 of the wrapped bale 44.

Each label of the plurality of labels is configured to secure the tail 51 of the bale wrap 26 of the wrapped bale 44 in conjunction with the tacky surface on the interior of the bale wrap. In particular, the plurality of labels is configured to secure the tail 51 of the bale wrap 26 for at least six months. In addition, the plurality of labels is configured to secure the tail 51 of the bale wrap 26 in the presence of up to at least 150 miles per hour wind (i.e., hurricane force wind). Further, each label of the plurality of labels is configured to be water resistant (as well as weather and ultraviolet resistant) for at least six months. The number of labels attached to the tail 51 may vary. In certain embodiments, at least five labels may be attached to the tail 51 to ensure securing of the tail 51. In certain embodiments, at least three labels may be attached on a central portion (e.g., central portion 38 in FIGS. 2 and 3) of the bale wrap 26 along the tail 51. In certain a label may be placed on one or both longitudinal ends of wrapped bale 44 (e.g., on one or both shoulders 36, 40 of the bale wrap 26 in FIGS. 2 and 3).

In certain embodiments, each label of the plurality of labels may be made of a masking tape with low density polyethylene (LDPE) backing (although the construction of the plurality labels may be different). Information may be printed on the labels. For example, the information may include identification information for the wrapped bale 44. The identification information may facilitate identification and tracking of the wrapped bale 44. For example, in certain embodiments, the identification information may include a machine-readable code, such as a bar code or a quick response (QR) code. Accordingly, the identification information may enable an automated system to identify the wrapped bale 44 while the wrapped bale 44 is in the field 14 and while the wrapped bale 44 is being transported, thereby facilitating tracking of the wrapped bale 44. Furthermore, in certain embodiments, the identification information may include text (e.g., alone or in combination with the machine-readable code) that includes an identification code (e.g., unique to each wrapped bale 44), field location information (e.g., determined by the controller via feedback from a spatial locating device, such as a global positioning system receiver, when the wrapped bale 44 is deposited on the field 14), the date and time of harvest, weather information, bale moisture at baling, a bale weight, planting information (e.g., planting date/time, fertilizer application date/time, etc.), baler operator information, fertilizer information, yield information, seed type, other suitable information, or a combination thereof. In addition, in certain embodiments, an identification code (e.g., unique to each wrapped bale 44), field location information (e.g., determined by the controller via feedback from a spatial locating device, such as a global positioning system receiver, when the wrapped bale 44 is deposited on the field 14), the date and time of harvest, weather information, bale moisture at baling, a bale weight, planting information (e.g., planting date/time, fertilizer application date/time, etc.), baler operator information, fertilizer information, yield information, seed type, other suitable information, or a combination thereof, may be associated with the machine-readable code. For example, the controller may output the machine-readable code (e.g., number corresponding to the machine-readable code) and the data associated with the identification information to a remote server, which may store the machine-readable code (e.g., number corresponding to the machine readable code) and the data associated with the identification information.

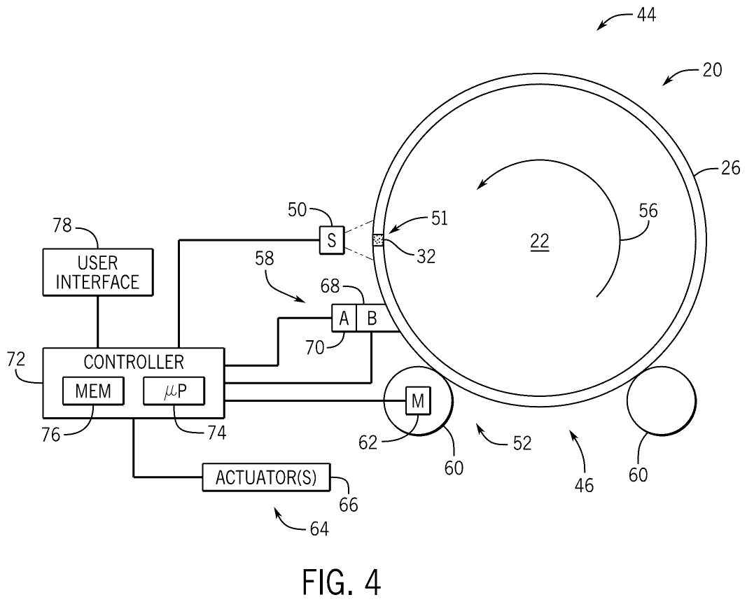

FIG. 4 is a schematic diagram of an embodiment of a bale carrier 46 that may be employed within the agricultural system 10 of FIG. 1. As previously discussed, after the bale 22 is wrapped with the bale wrap 26, the wrapped bale 44 (e.g., wrapped agricultural bale) is transferred to the bale carrier 46. In the illustrated embodiment, the baler 20 includes the bale rotation system 52 configured to drive the wrapped bale 44 to rotate within the bale carrier 46 of the baler 20. In the illustrated embodiment, the bale rotation system 52 includes two rollers 60 positioned at the bottom of the bale carrier 46. The rollers 60 support the wrapped bale 44 and enable the wrapped bale 44 to rotate within the bale carrier 46. While the bale rotation system 52 includes two rollers 60 in the illustrated embodiment, in other embodiments, the bale rotation system 52 may include more or fewer rollers 60 (e.g., 1, 3, 4, 5, 6, or more). Furthermore, each roller 60 may be positioned at any suitable location with respect to the circumference of the wrapped bale 44. While the bale rotation system 52 includes roller(s) 60 in the illustrated embodiment, in other embodiments, the bale rotation system 52 may include other suitable device(s) (e.g., alone or in combination with the roller(s) 60) configured to support the wrapped bale 44 and to enable the wrapped bale 44 to rotate within the bale carrier 46, such as bearing surface(s), belt(s), other suitable device(s), or a combination thereof.

The bale rotation system 52 includes a drive system 62 configured to drive the wrapped bale 44 to rotate within the bale carrier 46, such as in the rotational direction 56. In the illustrated embodiment, the drive system 62 is configured to drive one or more rollers 60 of the bale rotation system 52 to rotate, thereby driving the wrapped bale 44 to rotate (e.g., in the rotational direction 56). In certain embodiments, the drive system 62 includes one or more electric motors, one or more hydraulic motors, one or more pneumatic motors, or a combination thereof.

As previously discussed, the baler 20 includes an ejection system 64 configured to eject the wrapped bale 44 from the baler 20 (e.g., from the bale carrier 46 of the baler 20). In the illustrated embodiment, the bale ejection system 64 includes one or more actuators 66. In certain embodiments, the actuator(s) 66 of the ejection system 64 may be configured to drive/urge the wrapped bale 44 out of the baler 20. For example, in certain embodiments, the actuator(s) 66 may drive a ram to move the wrapped bale 44 out of the baler 20, and/or the actuator(s) 66 may drive a ramp to rotate to a lowered position to enable the wrapped bale 44 to roll out of the baler 20. In certain embodiments, both the ejection system 64 and the bale carrier may be located within the agricultural vehicle (e.g. agricultural system 10 in FIG. 1). In these embodiments, the actuator(s) 66 may be configured to open a door at the back end of the baler 20. For example, the door may be pivotally coupled to a body of the baler 20 via a pivot joint positioned at a top end of the door. The actuator(s) 66 of the ejection system 64 may be configured to drive the door to pivot upwardly about the pivot joint, thereby enabling the wrapped bale 44 to exit the baler 20 (e.g., the bale carrier 46). For example, the open door may enable the wrapped bale 44 to roll down a ramp to the field. After the wrapped bale 44 is ejected from the baler 20, the actuator(s) 66 may drive the door to the closed position, thereby enabling the bale carrier 46 to receive another wrapped bale.

In the illustrated embodiment, the baler 20 includes the monitoring system 50 configured to monitor for the identifier 32 (e.g., different color in the bale wrap 26 or identification tag) on the tail 51 of the bale wrap 26 of the wrapped bale 44. In certain embodiments, the monitoring system 50 may include a camera or sensor to look for and/or identify the identifier 32 (e.g., when the identifier 32 is a portion of the bale wrap 26 that is a different color from the rest of the bale wrap 26 as described in FIG. 2). In certain embodiments, the monitoring system 50 may include an RFID reader to read or identify the identifier (e.g., when the identifier 32 is an RFID tag as described in FIG. 3).

In the illustrated body, the baler 20 includes the labeling system 58 configured to attach a plurality of labels on the tail 51 of the bale wrap 26 of the wrapped bale 44 to secure the tail 51. The labeling system 58 includes to attach a plurality of labels along the tail 51 of bale wrap 26 upon locating the tail 51 of the bale wrap 26. The labeling system 58 includes a band 68 that is actuated (via one or more actuators of an actuation system 70) via a control signal to move towards the wrapped bale 44 and to attach the plurality of labels at the same time on the tail 51 of the bale wrap 26 of the wrapped bale 44.

In the illustrated embodiment, the baler 20 includes a controller 72 having a processor 74 and a memory 76. The processor 74 (e.g., a microprocessor or processing circuitry) may be used to execute software, such as software stored in the memory 76 for controlling components of the baler 20, such as the bale rotation system 52, the monitoring system 50, the ejection system 64, and the labeling system 58. Moreover, the processor 74 may include multiple microprocessors, one or more “general-purpose” microprocessors, one or more special-purpose microprocessors, and/or one or more application specific integrated circuits (ASICS), or some combination thereof. For example, the processor 74 may include one or more reduced instruction set (RISC) or complex instruction set (CISC) processors.

The memory 76 may include a volatile memory, such as random-access memory (RAM), and/or a nonvolatile memory, such as read-only memory (ROM). The memory 76 may store a variety of information and may be used for various purposes. For example, the memory 76 may store processor-executable instructions (e.g., firmware or software) for the processor 74 to execute, such as instructions for controlling the bale rotation system 52, the monitoring system 50, the ejection system 64, and the labeling system 58. In certain embodiments, the controller 72 may also include one or more storage devices and/or other suitable components. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the bale rotation system 52, the monitoring system 50, the ejection system 64, and the labeling system 58), and any other suitable data. The processor 74 and/or the memory 76, and/or an additional processor and/or memory device, may be located in any suitable portion of the agricultural system.

Additionally, in the illustrated embodiment, the baler 20 includes a user interface 78 communicatively coupled to the controller 72. The user interface 78 may be configured to provide information to an operator. Additionally, the user interface 78 may be configured to enable operator interactions with components of the baler 20, such as control of the bale rotation system 52, the monitoring system 50, the ejection system 64, the labeling system 58, or a combination thereof. For example, the user interface 78 may include a display and/or other user interaction device(s) (e.g., button(s)) configured to enable operator interactions.

In the illustrated embodiment, the controller 72 is configured to control the bale rotation system 52, and the ejection system 64 to effectively print the identification information onto the bale wrap 26 of the wrapped bale 44. Accordingly, the controller 72 is communicatively coupled to the monitoring system 50, the bale rotation system 52 (e.g., to the drive system 62 of the bale rotation system 52, to the ejection system 64 (e.g., to the actuator(s) 66 of the ejection system 64), and to the actuation system 70 of the labeling system 58. To effectively secure the tail 51 on the wrapped bale 44, the controller 72 is configured to control the bale rotation system 52 to drive the wrapped agricultural bale 44 to rotate within the bale carrier 46 of the baler 20, to control the monitoring system to monitor for the identifier 32 located on the tail 51 of the bale wrap 26 disposed on the wrapped agricultural bale 44 to locate the tail 51, to cease rotation of the wrapped agricultural bale 44 upon detecting the identifier 32 and wrapped agricultural bale 44 being aligned with a location of attaching the plurality of labels via the labeling system 58, and to control the labeling system 58 to attach the plurality of labels along the tail 51 of the bale wrap 26 to secure the tail 51 of the bale wrap 26 upon locating the tail 51 of the bale wrap 26.

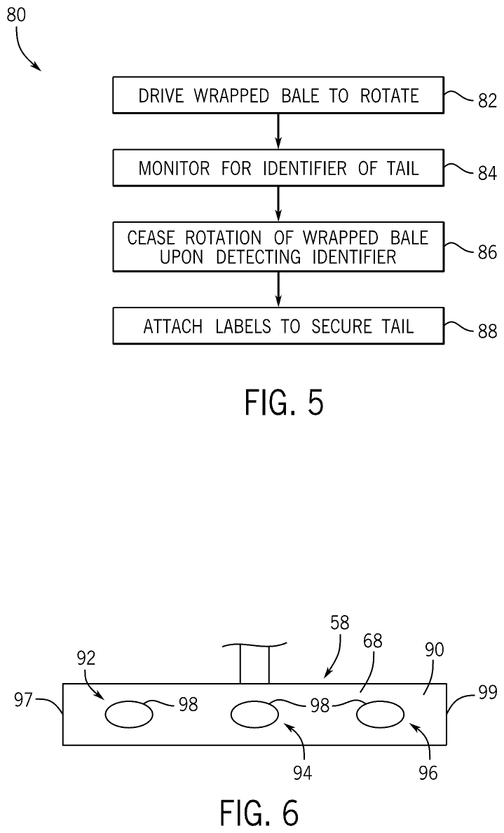

FIG. 5 is a flowchart of an embodiment of a method 80 a method for securing a tail on a bale wrap of a wrapped bale. The method 80 may be performed by the controller disclosed above with reference to FIG. 4 or any other suitable controller(s). Furthermore, the steps of the method 80 may be performed in the order disclosed herein or in any other suitable order. For example, certain steps of the method may be performed concurrently. In addition, in certain embodiments, at least one of the steps of the method 80 may be omitted.

The method 80 includes controlling the bale rotation system to drive the wrapped bale to rotate within the bale carrier of the baler (block 82). In certain embodiments, the drive system of the bale rotation system may be controlled to drive the roller(s) of the bale rotation system to rotate, thereby driving the wrapped bale to rotate in the rotational direction.

The method 80 also includes controlling the monitoring system to monitor for an identifier located on a tail of the bale wrap disposed on the wrapped bale to locate the tail (block 84). As noted above, in certain embodiments, the identifier may be a portion of the bale wrap that is a different color from the rest of the bale wrap outside the tail location. In certain embodiments, the identifier may be an identification tag (e.g., RFID tag).

The method 80 further includes controlling the bale rotation system to cease driving the rotation of the wrapped bale (block 86). The rotation of the wrapped bale is ceased upon both detecting the identifier and the tail (and the identifier) being aligned with the location where the labeling system will attach the labels to the tail to secure the tail.

The method 80 even further includes controlling the labeling system to attach the plurality of labels along the tail of the bale wrap of the wrapped bale to secure the tail of the bale wrap (block 88). Each label of the plurality of labels is configured to secure the tail of the bale wrap of the wrapped bale in conjunction with the tacky surface on the interior of the bale wrap. In particular, the plurality of labels is configured to secure the tail of the bale wrap for at least six months. In addition, the plurality of labels is configured to secure the tail of the bale wrap in the presence of up to at least 150 miles per hour wind (i.e., hurricane force wind). Further, each label of the plurality of labels is configured to be water resistant (as well as weather and ultraviolet resistant) for at least six months. The number of labels attached to the tail may vary. In certain embodiments, at least five labels may be attached to the tail to ensure securing of the tail. In certain embodiments, at least three labels may be attached on a central portion (e.g., central portion 38 in FIGS. 2 and 3) of the bale wrap along the tail. In certain a label may be placed on one or both longitudinal ends of wrapped bale (e.g., on one or both shoulders 36, 40 of the bale wrap 26 in FIGS. 2 and 3). In certain embodiments, each label of the plurality of labels may be made of a masking tape with low density polyethylene (LDPE) backing (although the construction of the plurality labels may be different). Information may be printed on the labels. For example, the information may include identification information as described above.

FIG. 6 is a schematic diagram of a bottom view of a portion of the band 68 of the labeling system 58. As depicted, a bottom surface 90 of the band 68 includes three different locations 92, 94, 96 having labels 98 to be applied to the tail of a bale wrap of a wrapped bale. Locations 92 and 96 are located adjacent longitudinal ends 97, 99 of the band 68. Location 94 is centrally located along the band 68 between the locations 92, 96. The number of locations having labels to be applied to the tail may vary. The structure of the band 68 may also vary. Actuation of the band 68 enables the labels 98 to be applied at the same time to the tail of the bale wrap.

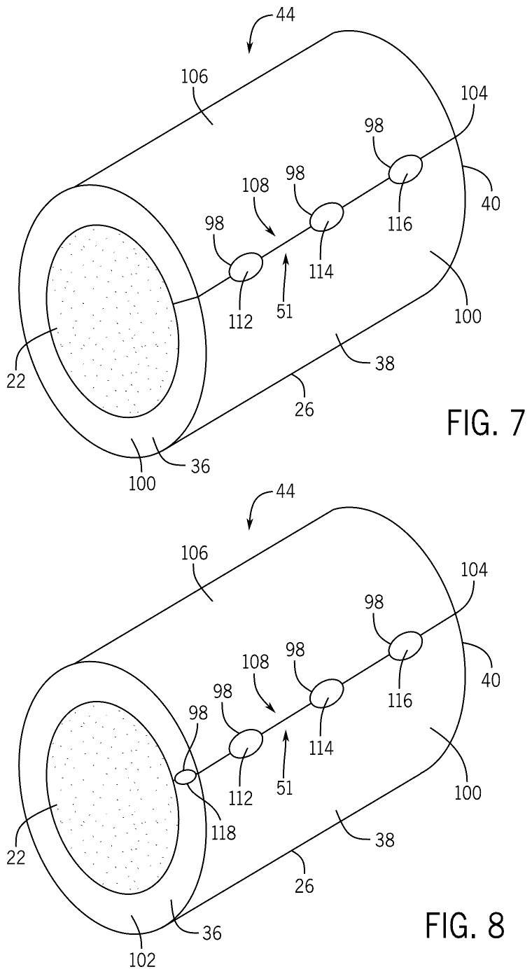

FIG. 7 is a schematic diagram of the wrapped bale 44 with the tail 51 secured by labels 98 (e.g., having the labels 98 on a lateral surface 106 only). The wrapped bale 44 includes the bale 22 with the bale wrap 26 disposed about it. The wrapped bale 44 includes the central portion 38 of the bale wrap 26 disposed about a lateral surface 100 of the bale 22 extending between longitudinal ends 102, 104 of the bale 22. The shoulders 36, 40 are respectively disposed about portions of the longitudinal ends 102, 104 of the bale 22. As depicted in FIG. 7, the plurality of labels 98 are disposed on a lateral surface 106 of the bale wrap 26 along the tail 51 of the bale wrap 26. In particular, each label 98 is partially disposed on the tail 51 and partially disposed on a non-tail portion 108 of the bale wrap 26 adjacent the tail 51. As depicted in FIG. 7, a first label 112 is disposed on the lateral surface 106 adjacent the longitudinal end 102, a second label 114 is disposed on the lateral surface 106 adjacent the longitudinal end 104, and a third label 116 disposed on the lateral surface 106 in the central portion 38 between the longitudinal ends 102, 104. In certain embodiments, as depicted in FIG. 8, labels 98 may also be disposed on the tail 51 on one or both of the shoulders 36, 40 of the bale wrap 26 (e.g., label 118 disposed on the lateral surface 106 on the shoulder 36 of the bale wrap 26). In certain embodiments (e.g., as depicted in FIGS. 7 and 8), each label 98 has a circular, oval, or elliptical shape to avoid any corners that may cause the label 98 to be lifted or displaced.

The plurality of labels 98 is configured to secure the tail 51 of the bale wrap 26 of the wrapped bale 44 for at least six months. In addition, the plurality of labels 98 is configured to secure the tail 51 of the bale wrap 26 of the wrapped bale 44 in the presence of up to at least 150 miles per hour wind (i.e., hurricane force wind). Further, each label 98 of the plurality of labels 98 is configured to be water resistant (as well as weather and ultraviolet resistant) for at least six months. The number of labels 98 attached to the tail 51 may vary. In certain embodiments, at least five labels 98 may be attached to the tail 51 to ensure securing of the tail 51. It should be noted that the identifier on the bale wrap 26 is not shown in FIGS. 7 and 8.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A system for securing a tail of a bale wrap, comprising:
a controller comprising a memory and a processor, wherein the controller is configured to:
control a bale rotation system to drive a wrapped agricultural bale to rotate within a bale carrier of a baler;
control a monitoring system to monitor for an identifier located on the tail of the bale wrap disposed on the wrapped agricultural bale to locate the tail; and
control a labeling system to attach a plurality of labels along the tail of the bale wrap to secure the tail of the bale wrap upon locating the tail of the bale wrap.

2. The system of claim 1, wherein the plurality of labels is configured to secure the tail of the bale wrap for at least six months.

3. The system of claim 2, wherein the plurality of labels is configured to secure the tail of the bale wrap in the presence of up to at least 150 miles per hour wind.

4. The system of claim 1, wherein an inner surface of the bale wrap facing toward a center of the wrapped agricultural bale is tacky and configured to assist in securing the tail of the bale wrap when adhered to an outer surface of the bale wrap facing away from the center of the wrapped agricultural bale.

5. The system of claim 1, wherein each label of the plurality of labels is configured to be water proof for at least six months.

6. The system of claim 1, wherein the identifier comprises a radio frequency identification tag.

7. The system of claim 1, wherein the identifier comprises a portion of the bale wrap having a different color from the rest of the bale wrap.

8. The system of claim 1, wherein the controller is configured to control the labeling system to attach a first label, a second label, and a third label of the plurality of labels on a lateral surface of the bale wrap extending between longitudinal ends of the wrapped agricultural bale, wherein the first label is attached adjacent a first longitudinal end of the longitudinal ends, the second label is attached adjacent a second longitudinal end of the longitudinal ends, and the third label is attached at a central location between the first longitudinal end and the second longitudinal end.

9. The system of claim 1, wherein the controller is configured to control the labeling system to attach each label of the plurality of labels on both an end of the tail of the bale wrap and a non-tail portion of the bale wrap.

10. The system of claim 1, wherein the controller is further configured to control a bale wrapping system to utilize a continuous roll of bale wrap to wrap agricultural bales, wherein the continuous roll of bale wrap comprises a plurality of identifiers located at regions of the bale wrap designated to form respective tail ends of wrapped agricultural bales.

11. A method for securing a tail of a bale wrap, comprising:
controlling, via a controller comprising a memory and a processor, a bale rotation system to drive a wrapped agricultural bale to rotate within a bale carrier of a baler;
controlling, via the controller, a monitoring system to monitor for an identifier located on the tail of the bale wrap disposed on the wrapped agricultural bale to locate the tail; and
controlling, via the controller, a labeling system to attach a plurality of labels along the tail of the bale wrap to secure the tail of the bale wrap upon locating the tail of the bale wrap.

12. The method of claim 11, wherein the plurality of labels is configured to secure the tail of the bale wrap for at least six months.

13. The method of claim 12, wherein the plurality of labels is configured to secure the tail of the bale wrap in the presence of up to at least 150 miles per hour wind.

14. The method of claim 11, wherein an inner surface of the bale wrap facing toward a center of the wrapped agricultural bale is tacky and configured to assist in securing the tail of the bale wrap when adhered to an outer surface of the bale wrap facing away from the center of the wrapped agricultural bale.

15. The method of claim 11, wherein each label of the plurality of labels is configured to be water proof for at least six months.

16. The method of claim 11, wherein the identifier comprises a radio frequency identification tag.

17. The method of claim 11, wherein the identifier comprises a portion of the bale wrap having a different color from the rest of the bale wrap.

18. The method of claim 11, wherein controlling the labeling system to attach a plurality of labels comprises controlling the labeling system to attach a first label, a second label, and a third label of the plurality of labels on a lateral surface of the bale wrap extending between longitudinal ends of the wrapped agricultural bale, wherein the first label is attached adjacent a first longitudinal end of the longitudinal ends, the second label is attached adjacent a second longitudinal end of the longitudinal ends, and the third label is attached at a central location between the first longitudinal end and the second longitudinal end.

19. The method of claim 11, wherein controlling the labeling system to attach a plurality of labels comprises controlling the labeling system to attach each label of the plurality of labels on both an end of the tail of the bale wrap and a non-tail portion of the bale wrap.

20. A baler, comprising:
a bale rotation system configured to drive a wrapped agricultural bale to rotate within a bale carrier of the baler;
a monitoring system configured to monitor for an identifier located on a tail of a bale wrap disposed on the wrapped agricultural bale to locate the tail;
a labeling system configured to attach a plurality of labels along the tail of the bale wrap to secure the tail of the bale wrap upon locating the tail of the bale wrap; and
a controller comprising a memory and a processor, wherein the controller is communicatively coupled to the bale rotation system, the monitoring system, and the labeling system, wherein the controller is configured to:
control the bale rotation system to drive the wrapped agricultural bale to rotate within the bale carrier;
control the monitoring system to monitor for the identifier located on the tail of the bale wrap disposed on the wrapped agricultural bale to locate the tail; and
control the labeling system to attach the plurality of labels along the tail of the bale wrap to secure the tail of the bale wrap upon locating the tail of the bale wrap, wherein the plurality of labels is configured both to secure the tail of the bale wrap for at least six months and to secure the tail of the bale wrap in the presence of up to at least 150 miles per hour wind.
